(19) United States
(12) Patent Application Publication
(10) Pub. No.: US 2006/0044984 A1
(43) Pub. Date: Mar. 2, 2006

(54) File switching apparatus and its switching method

(75) Inventors: Aki Sato, Kawasaki (JP); Hisatomo Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/206,091

(22) Filed: Aug. 18, 2005

Related U.S. Application Data
(63) Continuation of application No. PCT/JP03/07275, filed on Jun. 9, 2003.

(51) Int. Cl. G11B 7/00

(52) U.S. Cl. 369/100

(57) ABSTRACT

A file switching apparatus comprises a file name storage unit for storing a name of file having been used up to a file switching time; two storage units, being two file contents storage units, comprising one storage unit in which contents of file used up to this time are copied and the other storage unit in which contents of new file are to be copied at the file switching time; and a switching unit for making the file name storage unit store a name of the file having been used up to the file switching time, copying contents of the new file in the latter storage unit and emptying the stored contents of the former storage unit at the file switching time.

### CROSS REFERENCE TO RELATED APPLICATION

This application is a continuation application of International PCT Application No. PCT/JP2003/007275 which was filed on Jun. 9, 2003.

### BACKGROUND OF THE INVENTION

1. Field of the Invention

The present invention relates to a file switching method, in particular to a file switching apparatus and switching method for switching files by handling an entire file as a subject to switching when data within a file is to be changed, while capable of accessing the file instead of engaging a reference lock when referring thereto.

2. Description of the Related Art

When renewing a file, a renewal lock, that is an exclusive control, is generally engaged for the renewing file to prevent it from a reference during the renewal.

Conventional techniques for renewing a file without such an exclusive control are found in the following documents:

[Patent document 1] Japanese patent laid-open application publication No. 07-182213, “File sharing system”

[Patent document 2] Japanese patent laid-open application publication No. 07-281934, “Renewal and restoration methods for a system file”

[Patent document 3] Japanese patent laid-open application publication No. 08-328933, “File access control method for parallel processing system”

The patent document 1 discloses a technique to allow other users to refer to a file being renewed in the previous version by allocating the file on an actual memory to the respective users' logical spaces, copying the file on the actual memory in an exceptional treatment, and renewing the copied file when renewing the file, thus eliminating a need for exclusive controls for those users.

The patent document 2 discloses a method to accomplish a renewal of the file being denied for access by the OS (operating system) by software, in the method of which the same OS is stored in two memory domains, a first working OS is deactivated to be replaced by a second OS, and the file is renewed (i.e., file switching) by using the function of the second OS when renewing a file.

The patent document 3 discloses a file access control method to furnish with a reference buffer for page reference and a renewal buffer for page renewal, create a page for a new version when renewing a page and thereby eliminate an overhead due to an exclusive control of the file.

All the above noted conventional techniques, however, basically aim at a file renewal, that is, the file renewal including a partial change of the data within the file, which is different from the aim of the present invention, that is, a catalog switching.

There exists a later described catalog file as the one in need of a file switching instead of a partial data change therein. The catalog file is defined as the one describing the relationship between the location of a resource specified by a URI (uniform resource identifier) and an entity existing in the outside when there is a reference processing of the external entity as a processing within a format conversion of an XML document, for example. The catalog file, generally created in a client personal computer and file-transferred to a server collectively for a format conversion, is handled as one file for convenience, with the server retaining three versions of a catalog file, i.e., the previous, current and new versions, vis-à-vis a version up, for instance, to be subjected to a file switching processing for switching from the current to a new versions on as required basis.

In the above described patent document 1, a file is copied and renewed merely and there is no file switching processing as the present invention intends for.

Meanwhile, the patent document 3 likewise does not aim at a file switching, and stores a page of the new version created on the renewal buffer only temporarily, thus facing a problem of having to store it in a page for reference afterwards.

The technique disclosed by the patent document 2 is the one applicable to updating an application used on the Web for instance, which is useful to revert back to the older version when the updated version is rather problematic. The technique is unrelated to an exclusive control such as a lock at reference or renewal, having a problem of being unable to apply to a file switching that the present invention is intended for.

The following is a further description of file switching processing intended by the present invention while referring to FIGS. 1 and 2.

FIG. 1 describes a conventional example of reference method for a catalog file. The catalog file, created in a client and transferred to a server, that is, registered therein, may generally exist in a plurality thereof vis-à-vis an upgrade. There is, however, only one file which is actually used as a reference, that is, the current version (i.e., currently selected). And, if there are three catalog files for instance, the state includes the current version (i.e., currently selected), the previous version (i.e., previously selected) and the other version. The other version includes a test version and a switching (i.e., renewal) version newly sent from the client, that is, a file to be newly switched the currently selected. Within the aforementioned, one current version (i.e., currently selected) has to exist, and additionally required is the previously selected file in order to restore from an error occurrence at a file switching (i.e., renewal) for instance.

In FIG. 1, a reference application 10 engages a reference lock for an exclusive control when referring to a catalog file; and refers to a name of file stored in a currently selected file name storage unit 12 to do a reference to the file currently selected (i.e., the current version) from among catalog file clusters 14, 15 and 16. In FIG. 1, there is also a storage unit 13 for storing a previously selected file name; a currently selected file is an A catalog 14, a previously selected file is a B catalog 15 and the other file is a C catalog 16.

FIG. 2 describes a conventional example of catalog switching (i.e., renewal) processing method. As in the case of FIG. 1, a currently selected file name storage unit 12 stores a file name of the A catalog, and a previously selected file name storage unit 13 stores a file name of the B catalog. A renewal processing 11 starts a renewal processing by engaging a renewal lock in this state. A reference application 10 is inhibited from a file reference during the above described renewal processing.

The renewal processing 11 changes the content of the currently selected file name storage unit 12 to a C catalog, and that of the previously selected file name storage unit 13 to an A catalog in order to switch the currently selected file, that is, the A catalog 14, to a previously selected file and make the C catalog 16 as the currently selected file, thereby switching the currently selected file from the A catalog to the C catalog.

In such a catalog file switching (i.e., renewal) processing, it is fundamentally desirable to achieve a catalog file switching safely without stopping a file service. An error processing is necessary for a file switching process to recover from an error state. That is, for example, an error-recovery process correctly recognizes the currently selected file just prior to the error occurrence, so that a file switching process restores a state in which a reference to the file is allowed. Some examples of file switching process with such an error-recovery process are as follows: switching from the current version (i.e., currently selected) to a new version in order to reflect a new addition or renewal of catalog file, switching from a new version back to the current version when detecting a fault after reflecting a new addition or renewal, and switching between the business and a test versions in order to change the work contents (e.g., business versus testing) according to whether it is in business-hours or in off-hours.

In FIG. 2 for instance, if an error occurs such as an I/O error causing to store a totally different character string in place of the file name of the C catalog while changing a content of the currently selected file name storage unit 12, or an I/O error while changing a content of the previously selected file name storage unit 13, necessitating the renewal processing 11 to perform a recovery processing. It is not, however, necessarily easy to determine a cause of such error, hence facing a problem of recovery processing being very difficult.

### SUMMARY OF THE INVENTION

The purpose of the present invention is to provide a method for preventing an increase of processing time caused by locking a subject file at a file switching; and provide a file switching apparatus and switching method capable of detecting correctly a file name of file having been used as the current version (i.e., the currently selected) just prior to an error occurrence, and achieving firmly a recovery processing if the error occurred at a file switching (i.e., renewal).

The file switching apparatus according to the present invention, which switches an entire file to a new file if data within the file needs to be changed, comprises a file name storage unit, two file content storage units and a file switching unit.

The file name storage unit is for storing a name of file having been used up to a file switching time, one of the two file content storage units is for copying therein a content of file used up to now, and the other of the two file content storage units is for copying therein a content of new file at a file switching.

The file switching unit performs the processing of making the file name storage unit store a current version (i.e., the currently selected) filename, copying a new file content in the above described one of file content storage units, and making the above described other file content storage unit erase a storage content at the time of file switching.

Meanwhile, a file switching method according to the present invention comprises the steps of making a log buffer store a name of file used up to a file switching time as a current version (i.e., a currently selected), storing a copy of new file content in a determined space of a storage apparatus, and erasing a copy of current version file which has been copied in a different space of the storage apparatus up to a switching time. In the meantime, a computer readable storage medium is used for storing the program and data to accomplish the aforementioned method.

As described above, the present invention is comprised to copy a new file content in an empty space of a determined two storage spaces after storing a name of the file having been used up to a file switching time, and erase a content of copy of a current version file which has been copied in another storage space up to the switching time.

### BRIEF DESCRIPTION OF THE DRAWINGS

FIG. 1 describes a conventional catalog reference method;

FIG. 2 describes an operation of a conventional catalog file switching processing;

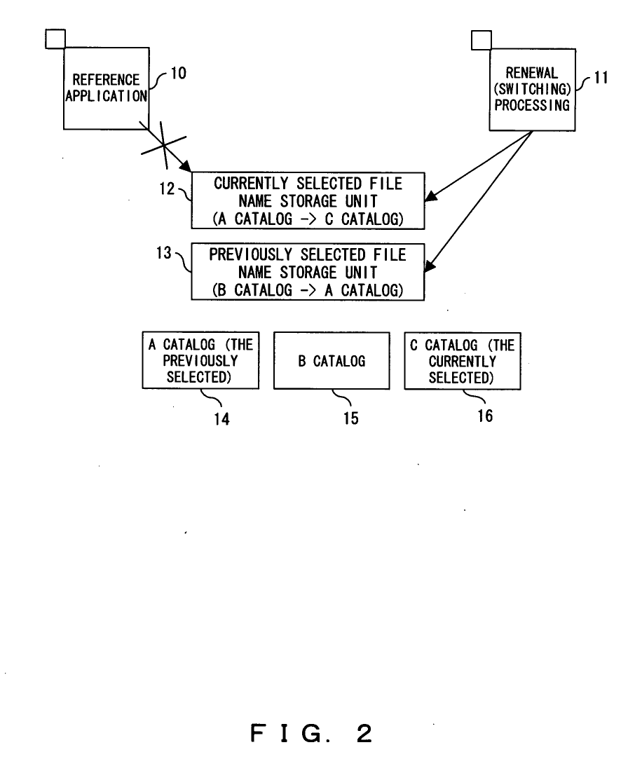

FIG. 3 is a fundamental configuration block diagram of file switching apparatus according to the present invention;

FIG. 4 is an overall configuration block diagram of a system applied by a catalog file switching method according to the present invention;

FIG. 5 exemplifies a configuration of catalog file shown by FIG. 4;

FIG. 6 shows an embodiment of catalog information file and that of catalog entry file;

FIG. 7 describes a file conversion processing in the system shown by FIG. 4;

FIG. 8 describes a catalog file switching processing in the system shown by FIG. 4;

FIG. 9 describes an operation of catalog file reference processing according to the present embodiment;

FIG. 10 describes an operation in a catalog file switching processing;

FIG. 11 describes a state at a normal completion of catalog file switching processing;

FIG. 12 describes a restoring operation for an error occurrence during a catalog file switching processing;

FIG. 13 is a detailed flow chart of catalog reference processing;

FIG. 14 is a detailed flow chart of valid catalog obtainment processing;

FIG. 15 is a detailed flow chart of catalog switching processing; and

FIG. 16 describes a loading of program onto a computer for accomplishing the present invention.

### DESCRIPTION OF THE PREFERRED EMBODIMENTS

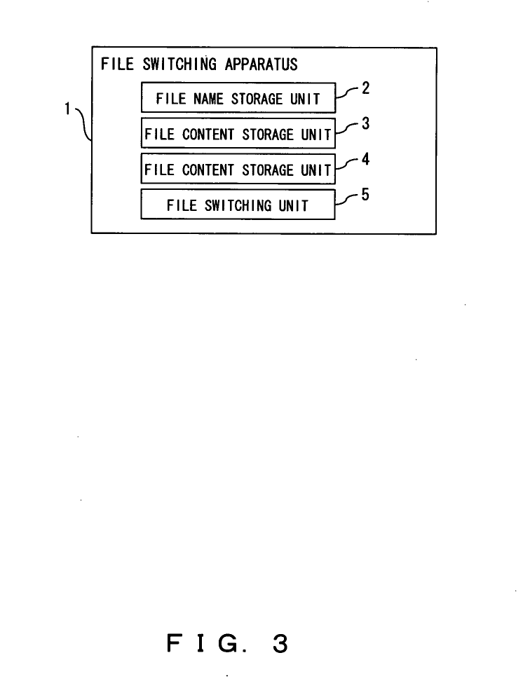

FIG. 3 is a fundamental configuration block diagram of file switching apparatus according to the present invention. In FIG. 3, the file switching apparatus 1, which switches an entire file to a new file if data within the file needs to be changed, comprises a file name storage unit 2, two file content storage units 3 and 4, and a file switching unit 5.

The file name storage unit 2 is for storing a name of file having been used up to a file switching time as the current version (i.e., the currently selected); one of the two file content storage units, 3 and 4, is for copying a content of file used up to now as the current version, and the other of the two file content storage units is for copying a content of new file at the file switching.

The file switching unit 5 performs the processing of making the file name storage unit 2 store a current version file name, copying a new file content in the above described one of file content storage units, and making the above described other file content storage unit erase a storage content at the file switching.

The file switching apparatus 1 may further comprise an access control unit for allowing a file reference application to access to a file content storage unit storing data, such as the above described one of file content storage units without engaging a reference lock when the file reference application tries to refer to a content of the current version file; and may further comprise a reference control unit for making the file reference application wait for the end of a state of critical region which is caused by the above described file switching unit 5 processing a file switching and then allowing a file reference after letting the file reference application obtain a renewal lock.

The file switching apparatus 1 may yet further comprise an error processing unit for making the file reference application access to a file having been used before the file switching as the current version by using the storage content of the file name storage unit 2 and for erasing the storage content of the other file content storage unit, if detecting an error in which a file content is stored in both the above described one of the two file content storage units and the other thereof when the file reference application tries to refer to the content of the current version file.

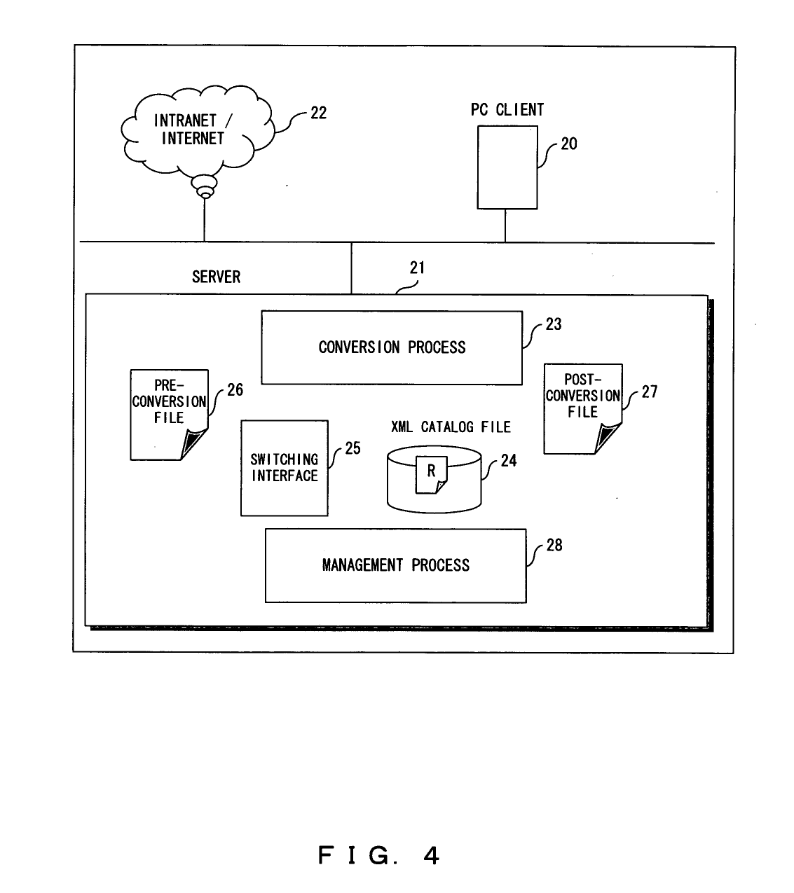

Let it describe a further detail of the preferred embodiment according to the present invention while referring to FIG. 4 and thereafter. FIG. 4 is an overall configuration block diagram of an XML document format conversion service system which is applied by the file switching method according to the present invention. The following is a description about a file switching method according to the present embodiment of the present invention, that is, a catalog file switching method.

In FIG. 4, let it assume that a client personal computer (PC) 20 is connected with a server 21, with this equipment being connected to an intranet or Internet 22. This system executes a service of converting format for an XML (eXtensible Markup Language) document by using a document style conversion function, XSLT (extensible Style Language Transformation) style sheet. This service requires a style sheet specified by a URI (Uniform Resource Identifier) for indicating where the information resource is located.

In order to read an XML document, an XML parser which reads an XML file, et cetera, and deploys the data in a memory is used. If there is a reference processing for an external entity specified in the document, the XML parser tries to obtain the resource thereof which is specified by a URI. Accordingly, a URI resolver mechanism is required to obtain the resource corresponding to the URI and supply it.

If the URI is a URL (Universal Resource Locater), the URI resolver mechanism generally refers to the Internet or a data base in an intranet to obtain a resource. In this case, the assumption is a connection to a network, whereas it is impossible to obtain such a resource off line. The system shown by FIG. 4 accordingly adopts a catalog system.

The catalog system supplies a catalog file which puts together catalog books, describing the relationships between external entities and the respective resource locations, to a URI resolver mechanism which then obtains a resource by using the catalog file in response to a demand for obtaining the resource when receiving such a demand. This makes it possible to cause the URI resolver mechanism to function off-line as well. On the other hand, it is necessary to renew the entire catalog file from the current to new versions, that is, a switching at opportune times in order to maintain the catalog books. Consequently, it is necessary to make a plurality of catalog files in the plurality of versions ready for different usages and select from among these, that is, switching between them.

Back to FIG. 4, the server 21 is furnished therein with a management process 28 for managing the whole, a conversion process 23 for use in a format conversion of XML document, an XML catalog file 24 which puts together catalog books and a switching interface 25 for switching the catalog files; and is configured for the conversion process 23 to convert a pre-conversion file 26 into a post-conversion file 27.

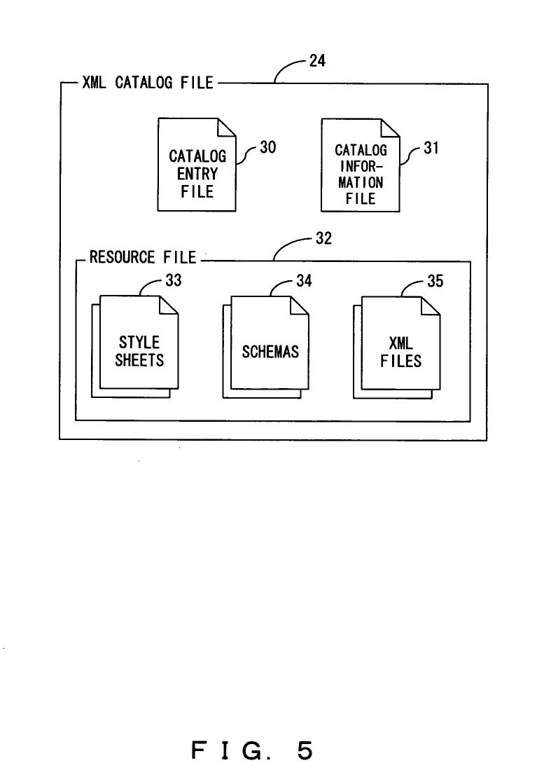

FIG. 5 exemplifies a configuration of XML catalog file 24. In FIG. 5, the XML catalog file 24 includes a catalog entry file 30 for describing the relationship between an external identifier/URI and a location of resource file, a catalog information file 31 for describing information about an XML catalog file, such as file name, function and comment, and a resource file 32 which is a file cluster referred to by the external identifier/URI, with the resource file 32 containing style sheets 33, schemers 34 and XML files 35.

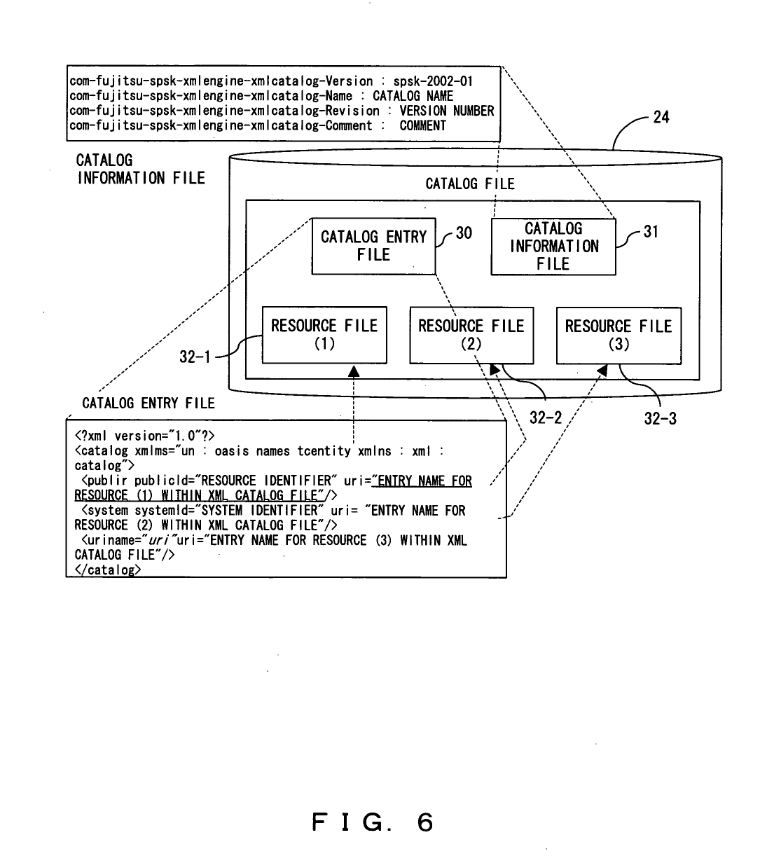

FIG. 6 shows an embodiment of catalog entry file 30 and that of catalog information file 31 contained by the XML catalog file 24. Let it assume here that resource files are made up of three files, i.e., (1) through (3) shown in the drawing. The catalog entry file 30 is an XML file which describes the relationship between an external identifier/URI and a location of resource file and which needs to be in compliance with “XML Catalog—Committee Specification 6 Aug. 2001” created by the OASIS (Organization for the Advancement of Structured Information Standards), which is the organization for standardizing specifications such as XML standard.

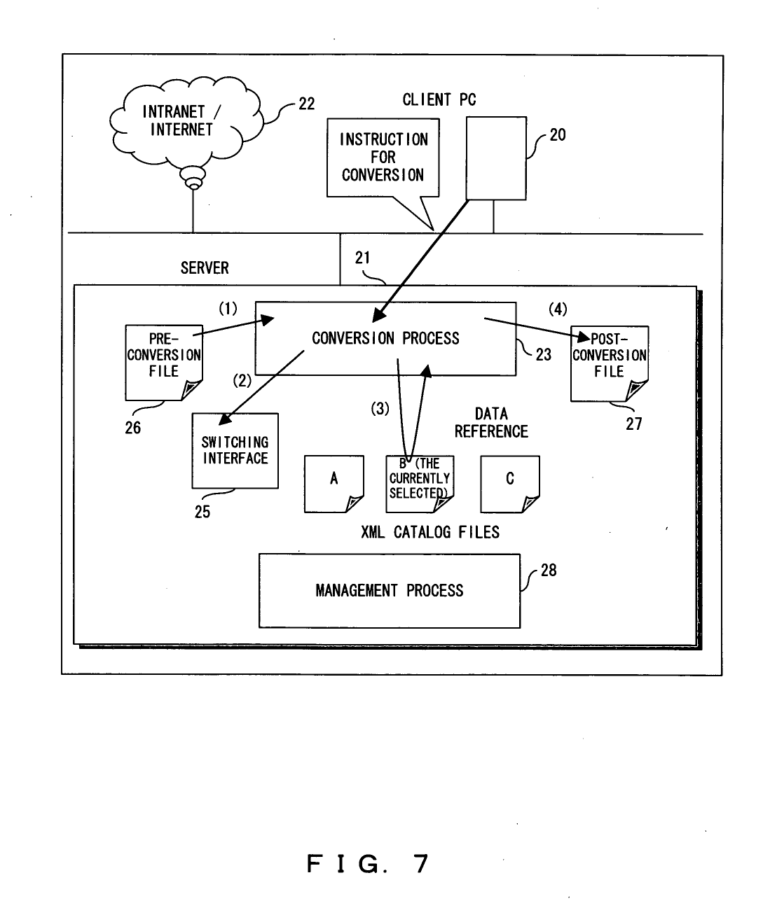

FIG. 7 describes a file conversion processing in the system shown by FIG. 4. In FIG. 7, as a client 20 instructs the conversion process 23 for a file conversion, processing is done in the steps (1): a pre-conversion file 26 is read, (2): the information about a catalog file to be used for the conversion processing, that is, about the current version catalog file, is obtained from among information possessed by the switching interface 25, (3): the current version catalog file, that is, the file B, is referred to, and (4): a post-conversion file 27 is created by using the content of the catalog file, the file B in this case.

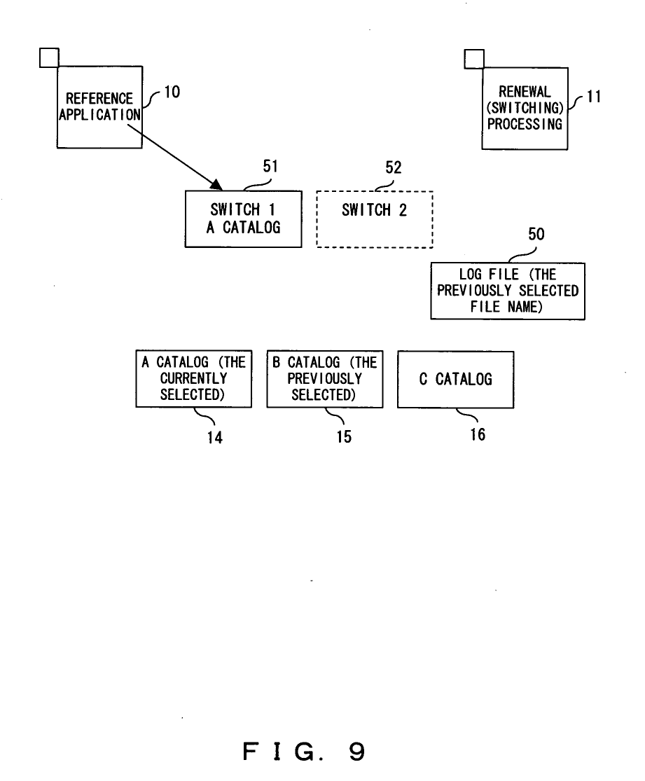

In the file conversion processing, the file B is directly referred to as the current version catalog file, which is for the convenience of the description herein. Note that a copy of the current version file is actually referred to as described for FIG. 9 and thereafter, which is the basis of the present embodiment.

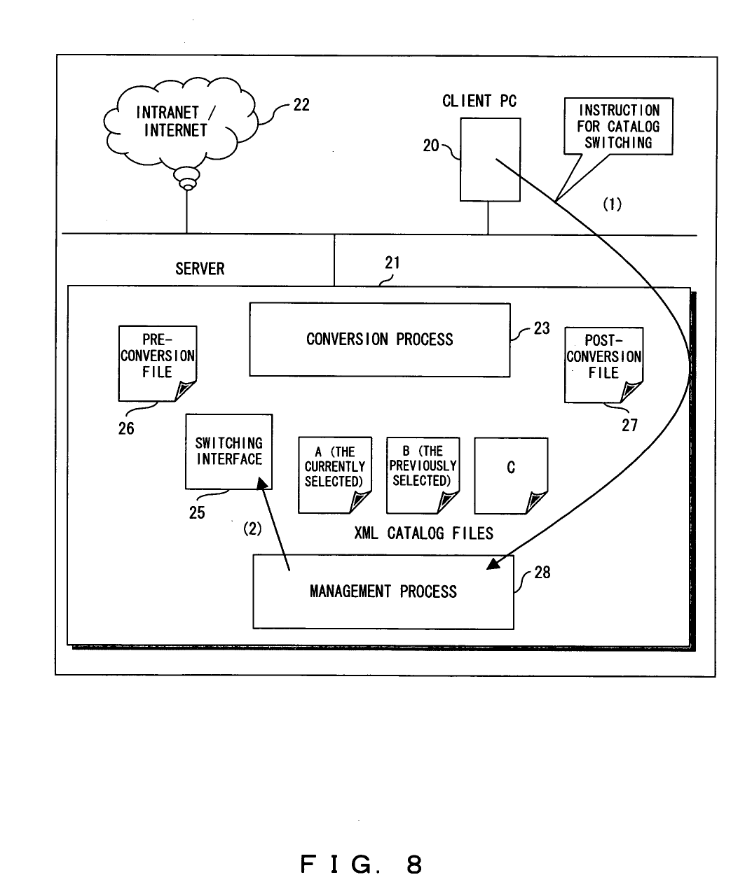

FIG. 8 describes a catalog switching processing in the system shown by FIG. 4. In FIG. 8, in the step (1): the client 20 instructs the management process 28 for a catalog file switching processing, (2): the switching interface 25 carries out a file switching processing in which the current version file, that is, the currently selected file is made as the A catalog, and the B catalog that was made as the currently selected, i.e., the current version file, in FIG. 7 is now renamed to the previously selected file.

FIG. 9 describes an operation of catalog file reference processing according to the present embodiment. In the present embodiment, the reference application is allowed to refer to a catalog without obtaining a reference lock in order to minimize the cost for a reference processing for the reference application by focusing on the fact that a catalog switching very rarely occurs.

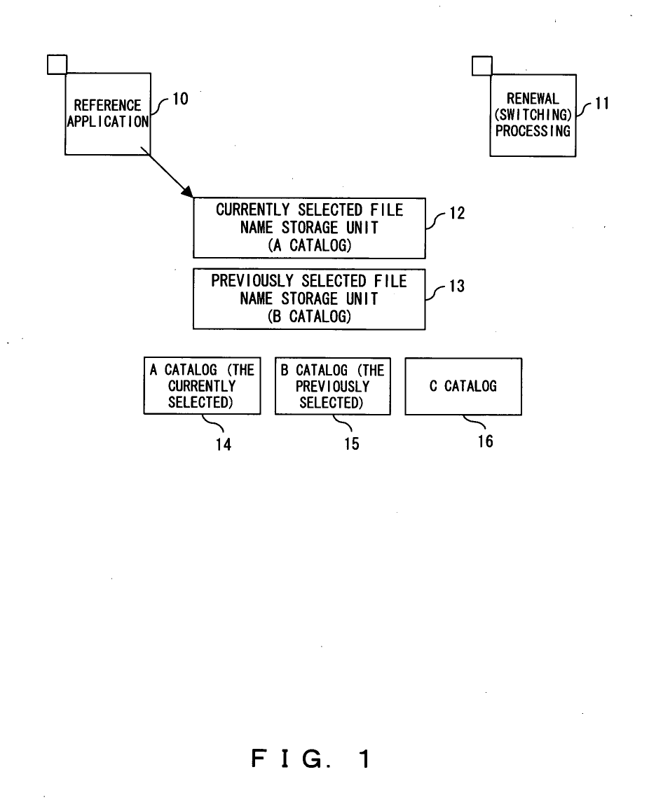

Comparing the processing of FIG. 9 with that of the conventional technique shown by FIG. 1, what is equipped now are: two of catalog file copy spaces (i.e., switches) 51 and 52, in place of the currently selected file name storage unit 12 and previously selected file name storage unit 13, and a log file 50 for storing a name of file having been selected up to a catalog switching time as the name of previously selected file.

In the case of FIG. 9, let it define that the currently selected file is the A catalog 14, and the file which was selected prior to the last file switching, that is, the previously selected catalog file is the B catalog 15; and that the file name of the B catalog stored in the log file 50 at the immediate past switching is still stored therein, instead of being erased. The content of the A catalog as the currently selected file is copied as is in one of the two storage spaces 51 and 52, in the 51 herein, while no data is stored (or a predetermined value for indicating the empty storage space) in the other storage space 52. In other words, the content of the B catalog, that is, now, the previously selected, used to be copied in the storage space 52. Now as a result of a successful catalog switching processing, no data is stored in the storage space 52.

Here, let it define the data storage space 51 as a switch 1, and the data storage space 52 as a switch 2. These names are related to the fact that either one of the two storage spaces stores a catalog data in a normal state allowing a catalog reference while the other stores no data, and every time a file is switched the storage space storing the copied data of a catalog file is also switched between the storage spaces 51 and 52 alternately; and the naming is expressing hardware-wise the processing performed by software.

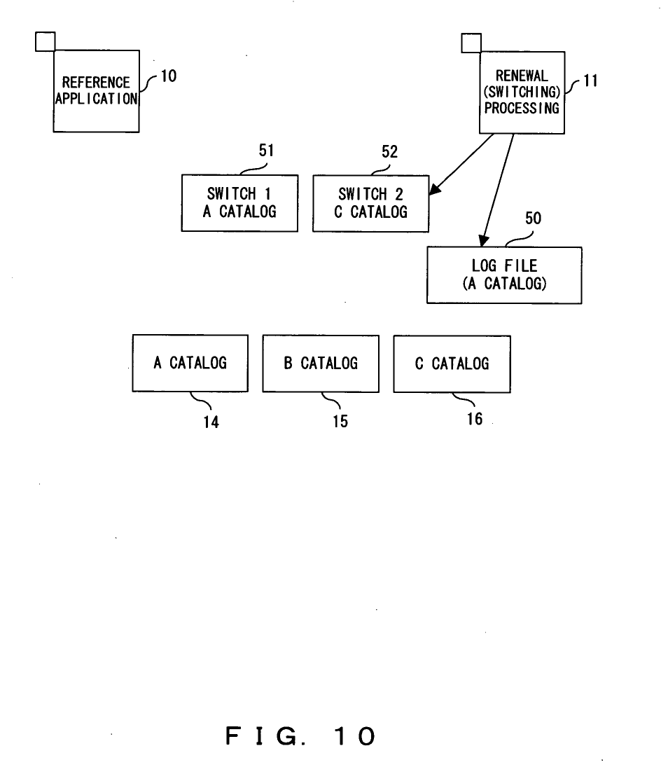

FIG. 10 describes a catalog renewal (i.e., switching) processing. Let it assume that a catalog renewal processing is performed to make the A catalog which was the currently selected in the state of FIG. 9 the previously selected and switch the C catalog 16, which has been sent from the client anew to be called as the aforementioned, to the currently selected.

The renewal processing 11 first stores the name of file as the currently selected up to now, that is, the “A catalog”, in the log file 50, followed by copying the content of catalog file to be made as the currently selected anew, that is, the C catalog, in the storage space 52 which has been empty in the state of FIG. 9 and erasing the catalog file, that is, the A catalog, stored in the other storage space 51, that is, the switch 1.

During the catalog switching processing, the state becomes a critical region in which the both storage spaces 51 and 52, that is, the switches 1 and 2, store data. If the reference application 10 tries to do a reference during the catalog switching processing, the state of critical region is detected making the reference application 10 retry it after the state of critical region is resolved.

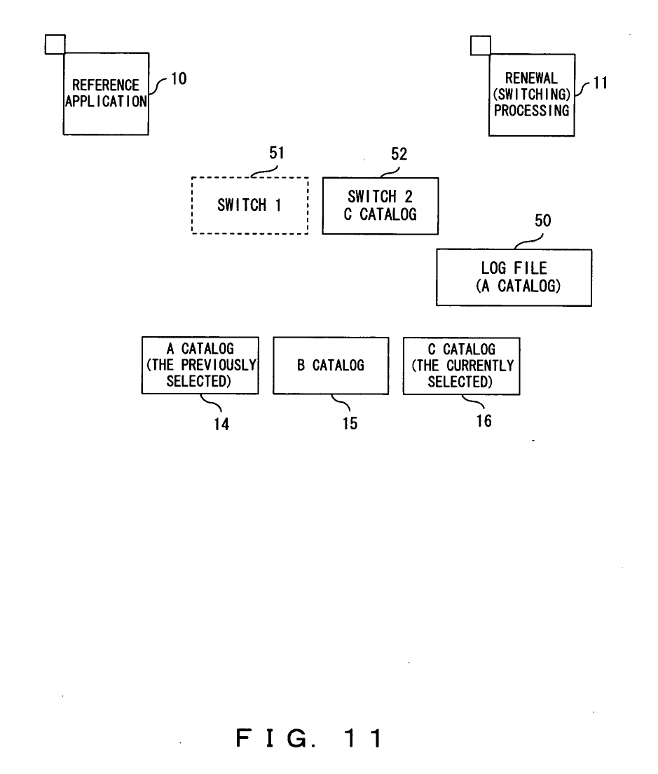

FIG. 11 describes a state at a normal completion of catalog file switching processing. As described in FIG. 10, the A catalog 14 becomes the previously selected file, and the C catalog 16 becomes the currently selected file. The content of the A catalog stored in the storage space 51, that is, the switch 1, is erased and the previously selected file name, that is, the name of the A catalog is stored in the log file 50. The storage content of the log file 50 is maintained until the next file switching time when it will be overwritten.

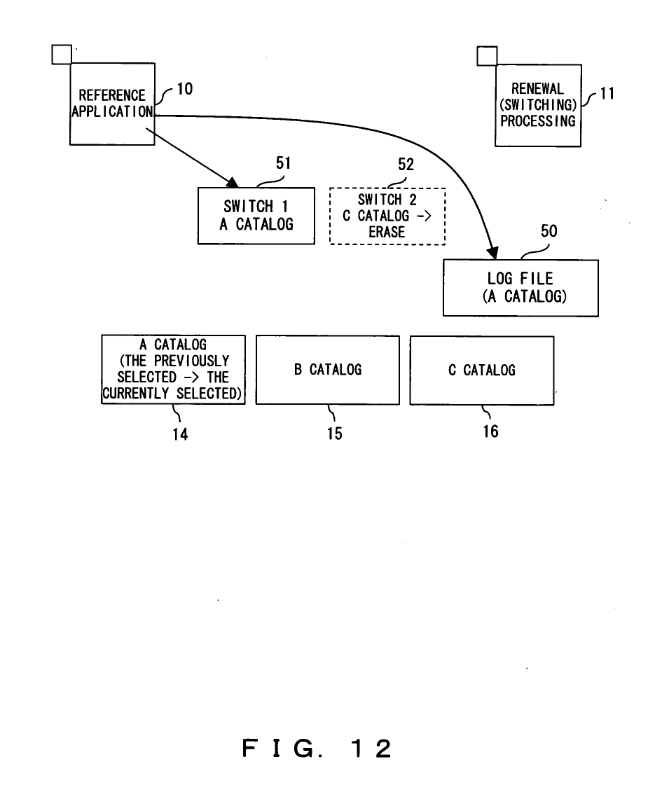

FIG. 12 describes an operation at an error occurrence during a renewal, that is, a switching processing. If an error occurs during the processing by the renewal processing 11, it is configured to finish the processing without restoring from the error. In such event of error occurrence, the catalog data copied in both of the two storage spaces 51 and 52, i.e., the switches 1 and 2 still remain, so does the file name of the currently selected prior to the renewal processing, that is, the name of the A catalog stored in the log file 50.

If the reference application 10 tries to refer to the currently selected file in this state, the fact that file data exist both in the two storage spaces 51 and 52 is detected, meaning in an error state, so that the reference application 10 detects that the currently selected file prior to the renewal processing was the A catalog by referring to the content of the log file 50, leaves the content of the A catalog in the switch 1, erases the content of the C catalog in the switch 2, changes the A catalog 14 among the catalog file clusters back to the currently selected file again, refers to the content of the file and finishes the processing. This makes it possible to access the file which was being used prior to the switching accurately, if an error occurs during a catalog switching.

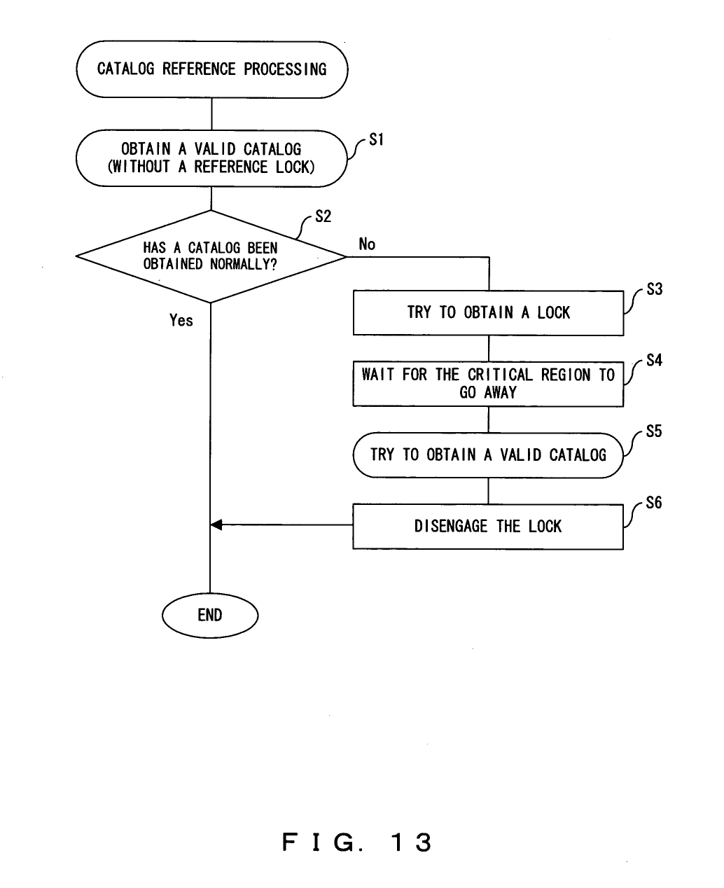

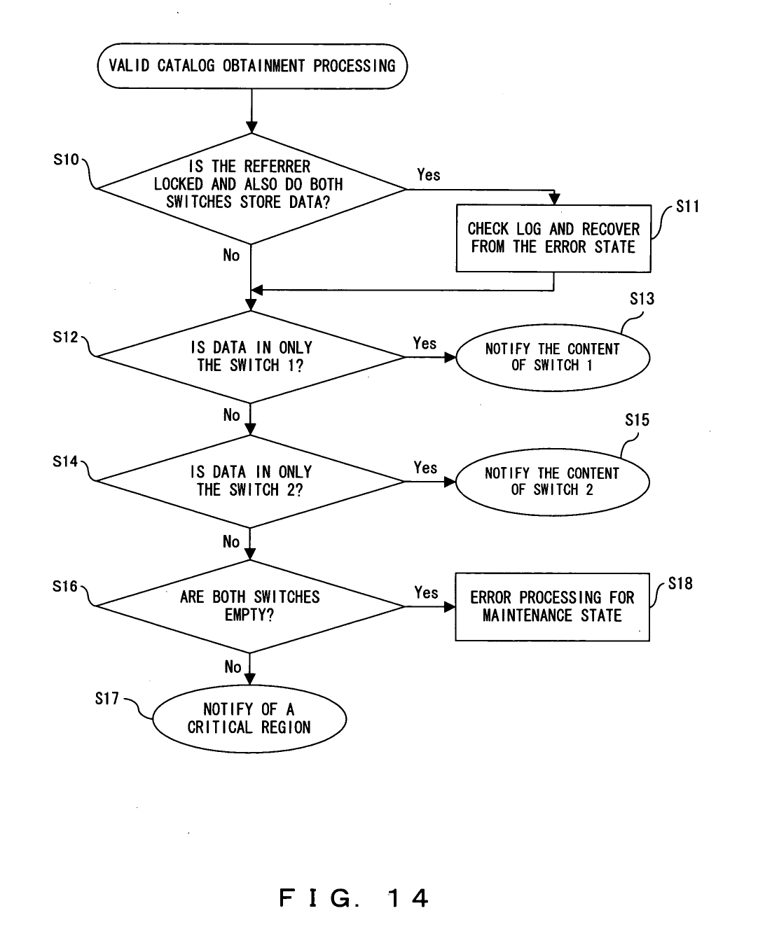

FIG. 13 is a flow chart of catalog reference processing according to the present embodiment. In FIG. 13, as a catalog reference processing is initiated, first processing is to obtain a valid catalog without a reference lock (step S1; simply “S1” hereinafter), the detail of which will be described in association with FIG. 14. Then judges whether or not a catalog is normally obtained (S2) and, if obtained normally, ends the processing as is.

If the judgment is that it was not normally obtained, meaning that a file switching processing is in progress, as will be described by FIG. 14, being in a state of critical region in which both the two storage spaces 51 and 52, that is, the switches 1 and 2 store file data, prompting to try to obtain a lock in order to wait for the critical region to go away (S3), and wait for the critical region to go away (S4). As the lock is actually obtained when the catalog switching is completed and the wait state is lifted accordingly, the processing is to obtain a valid catalog as in the step S1 (S5) and, if obtaining a valid catalog, the lock is disengaged to end the processing (S6).

Here, the meaning of “lock” in “try to obtain a lock” in the S3 is a renewal lock which the reference application tries to obtain as if it were performing a renewal processing. By trying to obtain a renewal lock, the catalog switching processing is finished, making it possible to lift the wait state at the time of obtaining the lock, thereby enabling the reference application to detect the timing for starting a valid catalog obtainment processing.

FIG. 14 is a detailed flow chart of valid catalog obtainment processing in the step S1 or S5 shown by FIG. 13. In FIG. 14, as the processing starts, first judges whether or not the referrer is locked and also the both switches store data (S10). The fact that the referrer is locked means the reference application has obtained a renewal lock following the wait state of the step S4 shown by FIG. 13 going away. If the both switches store data in this state, even after the state of critical region going away, it means an error state. Accordingly checks the content of the log file, leaves only the data stored in the switch storing the content of the file whose name is stored in the log file 50 as described in association of FIG. 12 and erases the data stored in the other switch in order to change the catalog file which was selected prior to the switching error back to the currently selected, that is, to recover from the error state (S1).

It judges whether or not data is in the switch 1 only (S12), when the processing of the S11 was done, or when the judgment of S10 is that the referrer is not locked or it is not the case in which both of the two switches store data. If the judgment result of S12 is “yes”, the content of the switch 1 is obtained (i.e., notified) (S13), followed by returning to the processing of FIG. 13.

If the state is not that the data is contained only by the switch 1 in the judgment of S12, it judges whether or not the data is in the switch 2 only (S14) and, if the judgment result is “yes”, obtains the content of the switch 2 (S15), followed by returning to the processing of FIG. 13.

If the result of judgment in S14 in “no”, then judges whether or not the both switches are empty of data (S16) and, if the judgment result is “no”, that is, the both switches contain data, the state is in a critical region in which the referrer is not locked even though the two switches store data in the judgment of S10, hence notifying of the state of critical region (S17) followed by returning to the processing of FIG. 13.

If the judgment in the S16 is that there are no data in the both switches, the state is in maintenance with the data in the two switches being erased, hence unable to continue the processing and accordingly conducting an applicable error processing (S18).

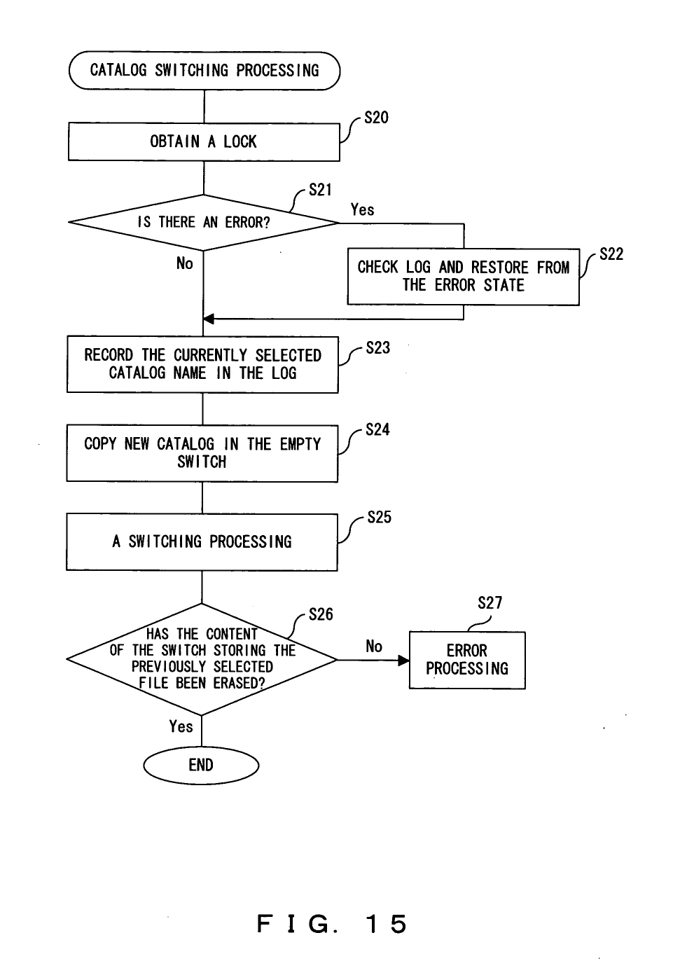

FIG. 15 is a flow chart of catalog switching processing. In FIG. 15, as the processing starts, it first obtains a lock, that is, a renewal lock (S20), judges whether or not there is an error, that is, both switches contain data (S21) and, if the judgment result is “yes”, checks the content of a log file to make the switch indicating the content of the file which was the currently selected” file prior to the error occurrence be the currently selected file (S22), followed by transition to the processing of the S23. If the judgment result for the S21 is “no”, the processing goes immediately to the S23.

Then, records the name of the currently selected catalog file (S23), in which the name of the A catalog is recorded even if there is some kind of error found in the S21, or a catalog switching is done normally as in FIG. 10 or FIG. 11.

Then, the processing copies the content of a new catalog, that is, of the catalog file to be the currently selected anew in the storage space of the now empty switch (S24) and performs a file switching processing, that is, to make the C catalog the currently selected and the A catalog the previously selected as exemplified by FIG. 11 (S25), followed by judging whether or not the data stored in the switch storing the previously selected file has been erased (S26) and, if the judgment result is “yes”, ending the processing. If there is some kind of error, carries out an error processing (S27).

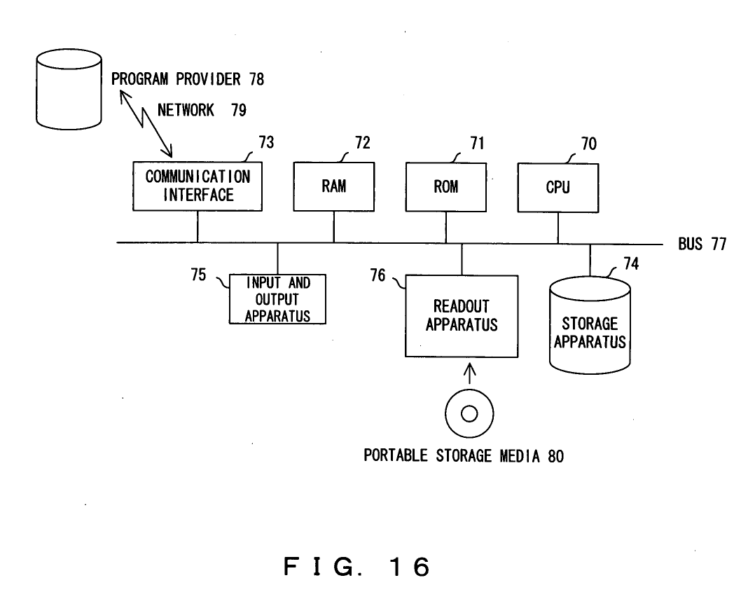

While the file switching apparatus and its switching method according to the present invention have been described in detail thus far, the file switching apparatus can be naturally comprised by a common computer system. FIG. 16 is a configuration block chart of such a computer system, that is, a hardware environment.

In FIG. 16, the computer system comprises a central processing unit (CPU) 70, a read only memory (ROM) 71, a random access memory (RAM) 72, a communication interface 73, a storage apparatus 74, an input and output apparatus 75 and a readout apparatus for portable storage media 76, with a bus 77 interconnecting all the aforementioned components.

The storage apparatus 74, comprehending various forms of storage apparatuses such as hard disk and magnetic disk, stores a program, or in ROM 71, shown by flow charts of FIGS. 13 through 15 and the one described in the claim 7 of the present invention so that the CPU 70 executes the aforementioned programs to accomplish the processing such as a catalog file reference, a file switching, a recovery from an error at a file switching, et cetera.

Such programs can be provided by a program provider 78 to be stored in the storage apparatus 74, for example, by way of a network 79 and communication interface 73; or stored in a commercialized and distributed portable storage medium 80, set in the readout apparatus 76 and executed by the CPU 70. The portable storage medium 80, comprehending various forms of storage media such as CD-ROM, flexible disk, optical disk, magneto optical disk, DVD, stores the program so as to be read out by the readout apparatus 76, thereby making it possible to accomplish the catalog file switching, et cetera of the present embodiment.

As described in detail, in a file switching method for switching an entire file to a new file when data within a file is to be changed, it is possible for a file referrer to recognize correctly the current version file which functioned rightly and perform a file reference processing if a conflict with a file switching processing occurs, or an error occurs during a file switching according to the present invention. Also, the file referrer can perform a recovery processing at an error occurrence safely and reliably. This improves the reliability of catalog switching, greatly contributing to an improvement in usefulness of such files, particularly catalog files.

### APPLICABILITY TO INDUSTRIES

The present invention is applicable to all industries using a file in the form of switching an entire file to a new file when data within a file is to be changed; and in particular, to all industries operating a product production, a business, et cetera, while actually using files which are seldom switched and frequently referred to.

What is claimed is:

1. A file switching apparatus for switching files, comprising:
a file name storage unit for storing a name of file having been used up to a file switching time;
two file content storage units, comprising a first storage unit in which a content of file used up to this time is copied and a second storage unit in which a content of new file is to be copied at a file switching time; and
a file switching unit for making the file name storage unit store a name of file having been used up to the file switching time, copying a content of new file in the second storage unit and emptying a stored content of the first storage unit at the file switching time.

2. The file switching apparatus according to claim 1, further comprising
an access control unit which permits a reference application to access without engaging a lock to one of said two file content storage units where a content of file is stored when the reference application tries to refer to the content of the current version file to be used at this time.

3. The file switching apparatus according to claim 1, further comprising
a reference control unit which makes a reference application wait for an end of state of critical region and then allows a reference to file if said file switching unit performs a file switching processing and it causes a state of critical region when the reference application tries to refer to the content of the current version file to be used at this time.

4. The file switching apparatus according to claim 1, comprising
an error processing unit which makes a reference application to access to a file having been used as a current version prior to an error occurrence according to a stored content of said file name storage unit and erases a copied content in said second file content storage unit, if detecting an error state in which both of said two file content storage units store data of files when the reference application tries to refer to the content of the current version file to be used at this time.

5. The file switching apparatus according to claim 1, wherein said file is a catalog file which lists information in a catalog form.

6. A file switching method, comprising the steps of
making a log buffer store a name of file having been used up to a file switching time;
storing a copy of a content of new file in a designated space of a storage apparatus; and
emptying a space, being a designated different space of the storage apparatus, which has stored a copy of a content of file being used up to a file switching time.

7. A computer-readable storage medium storing a program used to direct a computer to switch files, said program comprising:
making a log buffer store a name of file having been used up to a file switching time;
storing a copy of a content of new file in a designated space of a storage apparatus; and
emptying a space, being a designated different space of the storage apparatus, which has stored a copy of a content of file being used up to a file switching time.

8. A computer-readable storage medium storing a program according to claim 7, used to direct a computer to execute the further procedure of
permitting a reference application to access without engaging a lock to one of said two designated storage spaces where a content of file is stored when the reference application tries to refer to the content of the current version file to be used at this time.

9. A computer-readable storage medium storing a program according to claim 7, used to direct a computer to execute the further procedure of
making a reference application wait for an end of state of critical region and then allowing a reference to a file if a file switching processing is performed and causes a state of critical region when the reference application tries to refer to the content of the current version file to be used at this time.

10. A computer-readable storage medium storing a program according to claim 7, used to direct a computer to execute the further procedure of
making a reference application to access to a file having been used as a current version prior to an error occurrence according to a stored content of said log buffer and emptying said designated space in which a copy of said new file content has been stored, if detecting an error state in which both of said two designated spaces store data of files when the reference application tries to refer to the content of the current version file to be used at this time.

11. A computer-readable storage medium storing a program according to claim 7, wherein said file is a catalog file which lists information in a catalog form.
